(19) United States
(12) Patent Application Publication
(10) Pub. No.: US 2016/0069737 A1
(43) Pub. Date: Mar. 10, 2016

(54) Weighing Scales

(71) Applicant: LAKELAND LIMITED, Cumbria (GB)

(72) Inventors: Matthew Canwell, Cumbria (GB); Michael Cane, Cambridgeshire (GB); Benjamin Strutt, Cambridge, Cambridgeshire (GB); Ian Radcliffe, Cambridge, Cambridgeshire (GB); Robert Curtis, Cambridge, Cambridgeshire (GB); Guillaume Parrin, London, Greater London (GB)

(21) Appl. No.: 14/784,543

(22) PCT Filed: Apr. 16, 2014
(86) PCT No.: PCT/GB2014/051201

§ 371 Date: Oct. 14, 2015

(30) Foreign Application Priority Data
Apr. 16, 2013 (GB) 1306885.3

(51) Int. Cl. G01G 21/22; G01G 21/28

(52) U.S. Cl. CPC G01G 21/22; G01G 21/28

(57) ABSTRACT

Scales include at least one transducer, a weighing pan arranged such that weight applied to the weighing pan is referred to the transducer, and electronics which receive an output from the transducer and drive a display to provide a user with a visible indication of the weight applied to the weighing pan. The transducer and electronics are contained in a sealed enclosure defined at least in part by a flexible water-tight membrane which is able to move and thereby (a) to accommodate changes of volume of the sealed enclosure without creating a pressure differential between the interior and the exterior of the sealed enclosure and (b) to accommodate movement of the weighing pan. The water-tight membrane may include a double film comprising a saturated salt solution between two films.

### CROSS REFERENCE TO PRIOR APPLICATIONS

This application is a National Stage of International patent application No. PCT/GB2014/051201, filed Apr. 16, 2014 and designating the U.S., which claims priority to Great Britain Patent Application No. 1306885.3, filed Apr. 16, 2013, both of which are incorporated herein by reference in their entirety.

### BACKGROUND OF THE DISCLOSURE

1. Field of the Disclosure

The present invention is concerned with weighing scales. In particular, although not necessarily exclusively, the invention is concerned with electronic weighing scales in which functional components are protected against damage by ingress of water.

The terms “weighing scales” and “scales” are used interchangeably herein to refer to a device for measuring the weight of an object. The word “weight” refers, as the skilled person will recognise, to the force that acts on an object due to gravity.

2. Related Art

Electronic scales are very widely known and used. Typical kitchen scales comprise:
a weighing pan for supporting an object to be weighed,
some form of housing or base which is able to rest stably on a supporting surface such as a worktop,
a transducer which is mounted on the base and supports the weighing pan so that weight acting on the pan is referred to the transducer, which is thus able to provide an output indicative of the weight,
electronics which receive the transducer's output, and
a display connected to and driven by the electronics to provide a user with a visible indication of the measured weight.

Note that the term “weighing pan” is used herein to refer to any form of platform or support able to receive the weight of the object being weighed, and does not otherwise imply any particular shape or mode of construction.

The weighing pan may for example be formed by a main housing containing the scales' working parts. In this case the housing may have depending feet to stand on a supporting surface, with each foot being coupled to the housing through a respective transducer so that the transducers collectively support (a) the weight of the housing and its contents, and (b) that of an item to be weighed. The scales' reading is the sum of the weights measured through the transducers, less the weight of the housing and contents.

Alternatively the scales may have a housing that movably supports a separately formed weighing pan through the transducer (or transducers).

The transducer in conventional kitchen scales is typically a load cell. One suitable load cell of widely known type comprises a cantilevered beam whose deflection is measured using a resistive electrical strain gauge.

Scales can become dirty in use. Kitchen scales for example may be contaminated with food and need to be kept clean for the sake of hygiene. Conventional kitchen scales typically have wipe clean exterior surfaces but their undesirable contaminants may be harboured in their interiors, and in small constructional features such as joins between components, such features often being inaccessible to the user and/or too delicate or prone to water damage to be routinely washed.

Hence it is desirable to make electronic scales capable of surviving more aggressive cleaning processes including immersion in water, and particularly washing in a dishwasher. To prevent damage to the scales in these processes, vulnerable components need to be protected from the effects of hot water and cleaning chemicals.

There are existing scales which have casings that are wholly or partly sealed against ingress of water to facilitate washing. One challenge in this context is to maintain the required seal while permitting the weighing pan to move freely, as it must to transmit applied weight to the transducer. A solution adopted in certain known scales is to couple the weighing pan to the transducer through some form of flexible bellows or diaphragm, which maintains the required seal while accommodating some movement of the pan. JP 2009258010A (Shinko Denshi KK) and JP 2005140625A (A & D Co. Ltd) provide examples.

There is a further problem created by sealing the scales' housing, however. A volume of air is sealed inside the housing. The pressure and dew point of this trapped air varies with temperature. External pressure also varies according to meteorological conditions, altitude changes between the point of manufacture and the point of use, etc. A variable pressure difference between the inside and the outside of the scales' housing can be expected to exert a variable biasing force on the weighing pan which would produce erroneous weight readings in use of the scales.

The prior art known to the applicant does include scales that have a sealed housing and incorporate arrangements for balancing internal and external pressures. However these are considered to be either unacceptably complex or incompatible with immersion washing and washing in a dishwasher. For example there are commercially available scales known to the applicant which are covered by a waterproof outer skin but which also have a hole in the skin through which pressure can equalise, the hole being covered by some form of dust filter. Such scales could fill with water when immersed.

JP 2003329509A discloses scales with a movable stopper forming a valve to open and close an opening in the scales' casing, the stopper being actuated by a supporting leg. It is believed that the intention is to open the casing and so equalise pressure and humidity of the trapped air when the scales are placed on a supporting surface ready for use. Lifting the scales from the supporting surface causes the casing to be sealed. The arrangement is relatively complex and its ability to survive the conditions in a domestic dishwasher, or in a domestic kitchen where it might be inadvertently opened during hand washing, is questionable. JP2005308656A describes a waterproof balance having a “waterproof filter” for providing communication between the interior and the exterior of the scales' casing. JP2006071391A (Yamato Scale Co. Ltd) describes a waterproof electrical scale which appears to have both (a) the type of bellows arrangement described above to allow its weighing pan to move and (b) a “pressure adjusting diaphragm”, formed separately from the bellows, to allow equalisation of internal and external; pressures. This too is considered excessively complex.

It is worth noting that dishwashers use quite extreme conditions in order to achieve effective cleaning. In particular, quite high temperatures (up to e.g. around 85° C.) are typically used to soften soil on dishware, to dry dishware, and to provide the required conditions for dishwasher detergent to operate as intended. Dishwasher detergent is typically formulated to provide acidic and alkaline conditions in different parts of the cleaning process. Items placed in dishwashers must be able to cope with the high temperatures and chemical activities of the detergents. Additionally it is not just high temperatures which present a problem, but also temperature variations: in a relatively short period of time an item will be exposed to temperatures ranging from ambient to high temperature and subsequently be allowed to cool to ambient temperature. Furthermore the items being washed must be able to withstand not only attack by liquid water but also water vapour and variations in humidity.

### SUMMARY OF THE DISCLOSURE

An object of the present invention is to provide improved electronic scales capable of surviving immersion washing and/or washing in a dishwasher. It is desired that the scales should be simple in construction and/or economical to manufacture.

In accordance with a first aspect of the present invention there are scales comprising at least one transducer, a weighing pan arranged such that weight applied to the weighing pan is referred to the transducer, and electronics which receive an output from the transducer and drive a display to provide a user with a visible indication of the weight applied to the weighing pan, wherein the transducer and electronics are contained in a sealed enclosure defined at least in part by a flexible water-tight membrane which is able to move and thereby (a) to accommodate changes of volume of the sealed enclosure without creating a pressure differential between the interior and the exterior of the sealed enclosure and (b) to accommodate movement of the weighing pan.

Thus the water-tight membrane can serve multiple purposes. It forms the sealed enclosure needed to protect working parts of the scales. Being flexible, and in some embodiments bag-like, it can move in and out to accommodate changes of volume in gas trapped inside the enclosure without sustaining a pressure difference between the inside and the outside of the enclosure. Also being flexible it can transmit the weight applied to the pan to the transducer without biasing the pan in a way that would impair the accuracy of the scales.

The water-tight membrane may be transparent, in which case the display can be placed within the sealed enclosure, being viewable through the water-tight membrane. User controls may also be within the sealed enclosure and actuable by a user through the water-tight membrane. For instance the controls may comprise membrane switches or capacitive switches. Push buttons and other switch technologies could also be used.

In preferred embodiments the weighing pan is outside the sealed enclosure and weight applied to the weighing pan is referred to the transducer through the water-tight membrane. Alternatively the weighing pan may be inside the sealed enclosure.

The scales preferably comprise a battery compartment which does not communicate with the sealed enclosure and which is openable to replace batteries but is provided with a seal to exclude water when the battery compartment is closed.

Other power sources including a battery compartment which is sealed during manufacture (i.e. such that a power source sits inside the waterproof enclosure) and charged via an induction charging arrangement, and a DC inlet sealed with an appropriate waterproof stopper, are also appropriate.

The water-tight membrane preferably comprises flexible plastics. Plastics laminates are suitable and are well known for packaging moisture sensitive products such as pharmaceuticals. They may be formed, e.g. thermoformed, to a desired shape. The water-tight membrane preferably forms a seal along its periphery with a base or housing of the scales, so that the sealed enclosure is defined by the base and the water-tight membrane together. This seal may be formed by welding or by clamping the periphery of the membrane between suitable components. In other embodiments the membrane may take the form of a partial or complete bag or envelope.

A cover may be placed over the water-tight membrane. In this way the membrane, which may be crumpled and somewhat unsightly, can be concealed.

Preferably the cover comprises a cut-away or window through which the display is viewable.

The display may be viewable through the base rather than through the waterproof film, in which case it is not necessary for the film to be transparent. For example the film may form a seal at part of the base of the product,

Preferably the scales are capable of being washed in a dishwasher, e.g. a domestic dishwasher, without suffering damage.

In accordance with a second aspect of the present invention there are scales comprising a housing, a weighing pan, and a transducer contained in the housing and arranged to support weight applied to the weighing pan so that the transducer provides an output indicative of the applied weight, a display supported by the housing and viewable from its exterior, and electronics connected to the transducer and to the display, the electronics receiving the transducer output and driving the display in response to provide a user with a visual indication of the applied weight, wherein the housing is permeable to water and the electronics and the display are protected in a waterproof enclosure, enabling the scales to be washed with water without damage.

One or more films or plastic materials or laminates may be used as the water-tight membrane of the first aspect. Likewise, one or more films or plastic materials or laminates may define the waterproof enclosure of the second aspect.

Any suitable film, plastic material or laminate may be used. Some possible and non-limiting examples include films, plastic materials or laminates made from or comprising polypropylene (PP), polyethylene (PE), especially high density polyethylene (HDPE), polyesters, especially polyethylene terephthalate (PET), polystyrene (PS), especially high-impact polystyrene (HIPS), polycarbonate (PC), polyvinylidene flouride (PVDF), polyvinylidene chloride (PVDC) and cyclic olefin copolymers (COC).

Monolayer films may be used to reduce cost and complexity but similar or better performance may be obtained by combining the certain polymers into multilaminate films or coating films by use of a spray, e.g. PVDC or PVDF may be applied to other film substrates in this way.

Polyoleofins are preferred, and of these, polypropylene films are particularly preferred. This is because polypropylene films have a range of desirable characteristics such as a melting or softening point in excess of the operating temperature of the dishwasher, excellent chemical resilience, high water vapour barrier properties, low water absorption, excellent weldability, high tear and puncture resistance, and wide availability due to extensive production for packaging purposes.

The water-tight membrane or waterproof enclosure may comprise two or more films. This provides a “double-bagging” effect to enhance the separation between internal and external components and enhance the protection of moisture-sensitive components.

The water-tight membrane or waterproof enclosure may comprise a double film comprising a saturated salt solution between two films.

The double film containing a saturated salt solution brings considerable further advantages in terms of dealing with humidity and mitigating against problems due to condensation. The films are, to a certain extent, permeable to water vapour, and this permeability often increases to significantly, in some cases exponentially, at the higher temperatures associated with dishwashing. The salt solution pouch acts as a barrier and also can vent humidity to the external environment after dishwashing. In accordance with the present invention, a salt solution is used which has an equilibrium humidity above the expected ambient humidity so that the solution may vent to atmosphere.

The saturated salt solution comprises a salt and water where the salt is provided in excess of its solubility in the water.

A preferred salt is sodium chloride as this is abundant, economical and non-toxic and provides a suitable equilibrium humidity for household use.

Other non-limiting examples of suitable salts [and their relevant % relative humidity (RH) at 25° C.] include:
Magnesium chloride 32.78%
Magnesium nitrate 52.89%
Sodium nitrate 74.25%
Ammonium chloride 78.57%
Ammonium sulphate 80.99%
Potassium chloride 85.06%
Potassium nitrate 93.58%
Potassium sulphate 97.30%

However, this is not an exhaustive list and other salts or combinations of salt may can be used. The choice of salt is caveated by the ambient humidity of where the product is to be used. In the UK, this is relatively high so a salt with a high % RH is preferably used. This allows the product to vent water vapour and thus reduces the amount of salt required. If the ambient humidity exceeds the equilibrium humidity of the salt there is a net ingress of water vapour into the salt and this becomes more rapidly consumed and thus a significantly larger amount of salt must be used to maintain the same product lifespan. Furthermore, the % RH of some saturated salt solutions may vary with temperature. The equilibrium humidity of sodium chloride is relatively stable with temperature, which is a further reason for it being preferred.

The saturated salt solution contains excess salt beyond solution saturation point, to act as a buffer and ensure that the water always contains the maximum possible amount of dissolved salt. This takes into account that solubility can vary depending on the conditions, e.g. depending on the temperature.

Salt solutions can cause severe corrosion problems. However, in the present case the salt solution is completely enclosed between two plastic films and therefore the salt only comes into contact with the films and not any other components.

### BRIEF DESCRIPTION OF THE DRAWINGS

Specific embodiments of the present invention will now be described, by way of example only, with reference to the accompanying drawings, in which: —

FIG. 1 is a side view of first scales embodying the present invention, a housing being cut away to reveal internal detail;

FIG. 2 is a perspective view of a base part of the first scales and of certain components carried by the base;

FIG. 3 is a perspective view of the base part and of a membrane which covers the base;

FIG. 4 is a perspective view of the first scales assembled and ready for use;

FIG. 5 is a further perspective view of the assembled first scales, showing the underside;

FIG. 6 is a side view of second scales embodying an aspect of the present invention, a housing being cut away to reveal internal detail;

FIG. 7 is a section in a vertical plane through third scales embodying the present invention;

FIG. 8 is a similar section through fourth scales embodying the present invention;

FIG. 9 is a side view of fifth scales embodying the present invention; and

FIG. 10 shows the principle of operation of a double plastic film comprising saturated salt solution.

### DETAILED DESCRIPTION OF THE DISCLOSURE

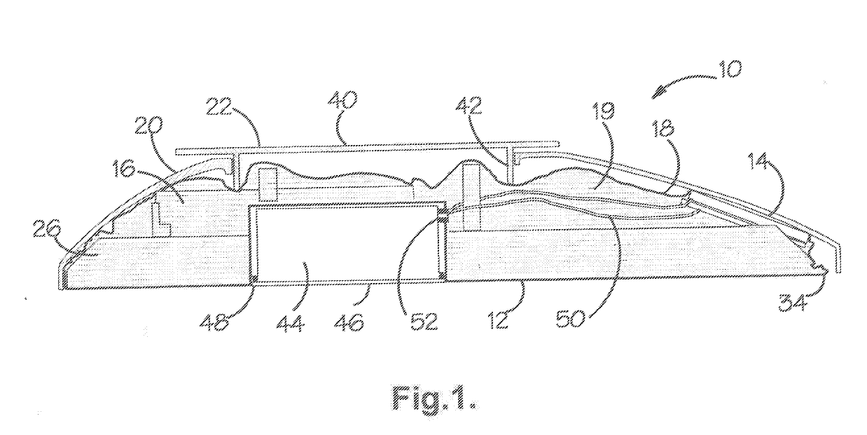

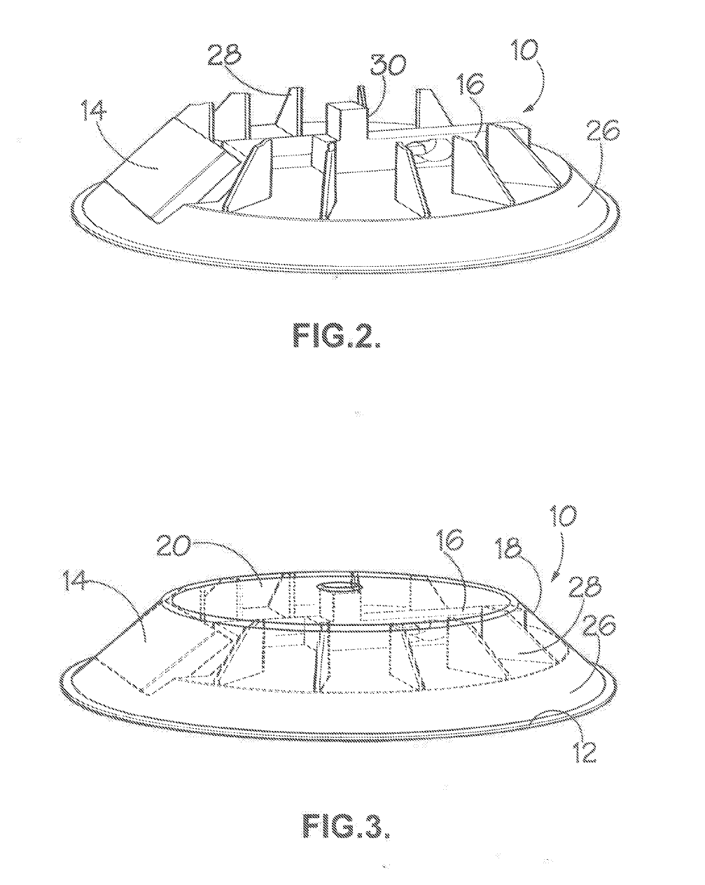

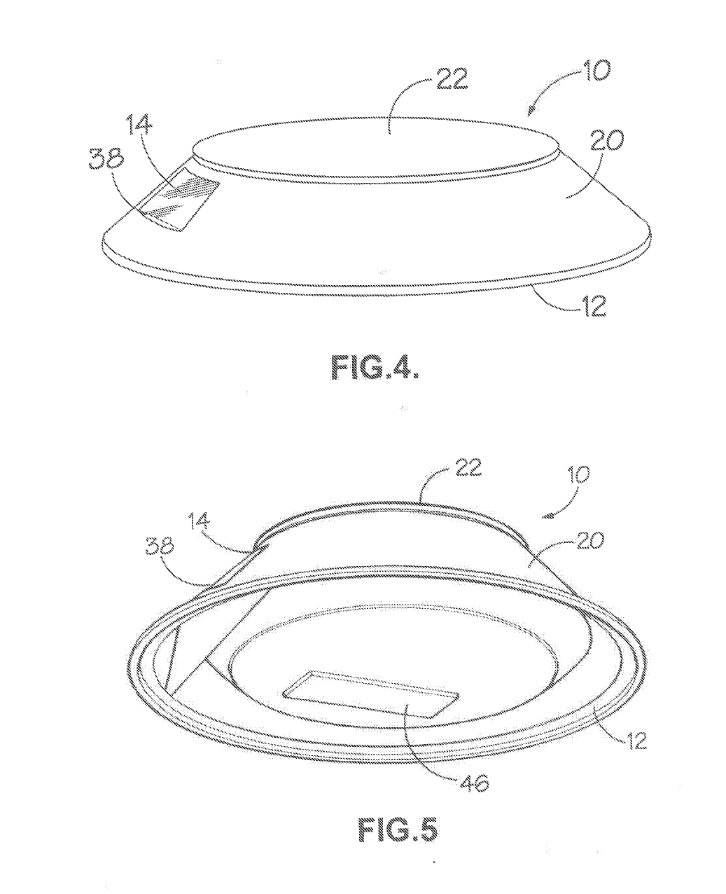

The scales 10 seen in FIGS. 1 to 5 are well suited to use in a domestic kitchen and are intended to be able to survive numerous dishwashing cycles. Briefly described, the scales 10 comprise a base 12 which supports a user interface or display and control panel 14 incorporating a printed circuit board carrying the scales' electronics. Also supported by the base 12 is a transducer in the form of a load cell 16. A membrane 18 covers the base and forms with it a sealed enclosure 19 in which the load cell 16 and the display and control panel are protected from water. A formed cover 20 (FIG. 4) lies over the membrane 18 and a weighing pan 22 sits atop the cover providing a platform for supporting items to be weighed. In FIG. 4 the cover is generally frusto-conical but in general this is not necessary. Suitable covers of other shapes can be used.

These components will now be described in more detail.

The base 12 is in the present embodiment a generally circular moulding, although it should be understood throughout that the shapes, materials and means of construction of the scales' components are presented herein merely by way of example and may be quite different in other scales embodying the present invention. The base 12 has a bottom surface (see FIG. 5) through which it stands upon a supporting surface, such as a worktop, in use. An inclined annular wall 26 leads to a set of upstanding vanes 28, forming an upwardly convergent frusto-conical envelope which supports the membrane 18 in a roughly similar shape, although it must be understood that the membrane 18 is free to move and distort. It is also important to note that the shape need not be frusto-conical.

The load cell 16 comprises a cantilevered limb whose root is secured to the base 12, the end of the limb opposite the root having an upstanding support member 30. Application of weight to the support member 30 causes the arm to bend and that bending is detectable by a strain gauge (which is not shown in the drawings but is incorporated in the load cell 16 and may comprise a resistive bridge circuit) to provide an output signal indicative of the applied weight.

The display and control panel 14 is not illustrated in detail herein since suitable devices are familiar to the skilled person. It has a visual display or interface for showing the measured weight and other information such as the currently selected units (kilograms, pounds and ounces etc). Typically simple LED or LCD displays can be used, although they need to be capable of surviving elevated temperatures during washing. The panel 14 also incorporates user controls. For example, there may be controls for selecting the units in which measured weights are displayed, for setting the displayed weight to zero etc. The controls are in this embodiment actuated through the membrane 18, which covers the display and control panel 14, but this presents no difficulties and for example membrane-type push buttons or capacitive switches sensitive to the presence of the user's forefinger can be used.

In other embodiments the display and the user controls may be formed as separate units. Other types of user interface could in principle be substituted.

The display and control panel 14 also incorporates the electronics required to convert the output of the load cell 16 to a digital value, and to drive the display to output this value in the selected weight units. Again, these aspects are well known from existing electronic scales and will not be described in detail.

The display and control panel 14 is to be seen by the user through the membrane 18, so the membrane is in the present embodiment transparent. Polyethylene and Polypropylene are examples of suitable materials for the membrane 18. Whatever material is chosen, the membrane 18 is to be flexible enough that it can deform to enable the volume of the sealed enclosure 19 that it defines to vary, without creating an appreciable pressure difference between the interior and the exterior of the sealed enclosure. To this end, the membrane 18 is bag-like in nature, in the present embodiment. Its material preferably also has a low moisture vapour transmission rate, to minimise moisture ingress and maximise the number of washes the scales can endure before a build up of moisture occurs in the enclosure 19, potentially causing condensation inside the sealed enclosure when the scales are removed from the hot dishwasher to a cool environment.

The sealed enclosure 19 is formed between the membrane 18 and the base 12, so a seal is needed between these parts. The periphery 34 of the membrane 18 may for example be heat welded or otherwise bonded to the base 12 to provide this. In other embodiments (examples will be described below) the periphery of the membrane 18 may be constrained, and the seal formed, by appropriate mechanical features. The membrane 18 may be thermo-formed to give it a shape which is beneficial to mechanical or aesthetic layout as seen in FIG. 3.

The membrane 18 may be of low rigidity and therefore undefined in shape, but it is largely concealed in the assembled scales by the frusto-conical cover 20, which is a stainless steel item in the illustrated embodiment although it need not be; it could for example be a plastics moulding. The cover 20 is supported by the base 12. It has a window 38 through which the display and control panel 14 is visible and accessible.

The weighing pan 22 is seen in FIG. 1 to comprise a substantially flat platform 40 with an annular depending wall 42 which locates in a circular opening of the cover 20. The weight of the pan 22 and of any object supported on it is referred through the membrane 18 and the support member 30 to the load cell 16. The weighing pan 22 may simply rest upon the support member 30, without being coupled to it. Alternatively a sealed coupling may be formed through the membrane 18 between the support member 30 and the weighing pan 22.

In one embodiment a desiccant such as silica gel may be placed in the sealed enclosure 19 to absorb moisture in the enclosure and so help prevent condensation on surfaces within it. The use of such a desiccant is generally not as effective as saturated salt solutions in controlling the humidity. Nevertheless, in some cases, it may be useful and may provide useful effect, e.g. with single film barriers.

A region of the enclosure may be designed to have an increased thermal conductivity compared to the other surfaces of the enclosure. This region will therefore cool more quickly when the scales are removed from the hot dishwasher into a cooler environment and therefore any condensation that may occur inside the enclosure will form preferentially on this region. In this way condensation that could otherwise occur on the on the electronics or inside the display window is avoided. This region of higher conductivity may be embodied by a thinner wall section of the base or by a piece of sheet metal which covers a hole in the base which is made from a plastic material. It may also be embodied by the flexible membrane.

To ensure that no condensation can occur behind the display any air cavities between the display itself and the window or flexible membrane are either avoided by the design of those components of if cavities occur are filled with an appropriate transparent gel or adhesive, therefore excluding any air.

The scales require electric power which in the present embodiment is supplied by disposable batteries which require periodic replacement. A battery compartment 44 is defined by the base 12 and does not communicate with the sealed enclosure 19. The battery compartment has a downwardly facing opening covered by a removable battery hatch 46. A seal is provided to prevent water from entering the battery compartment 44 when the battery hatch 46 is in place. In the present embodiment this takes the form of a peripheral “O” ring seal which can just be seen at 48 in FIG. 1. Some suitable retainer (not shown) such as a spring catch or screw, is provided to keep the battery hatch 46 in place during normal use but allow it to be removed by the user when the batteries require replacement. Wires 50, connecting the batteries (not shown) to the display and control panel 14, emerge from the battery compartment 46 into the sealed enclosure 19 through a seal 52 so that even when the battery compartment is open there is no path for water ingress to the sealed enclosure 19.

Trials have demonstrated that conventional electronics, including displays, and conventional batteries can all survive the temperatures experienced in a domestic dishwasher. The embodiment illustrated in FIGS. 1 to 5 thus provides a potentially inexpensive electronic scale which can be washed by immersion or in a dishwasher. The membrane 19 provides a simple and economical means of carrying out three functions: (a) it defines a sealed enclosure for those parts of the scales which would otherwise be vulnerable to water damage; (b) it allows the weighing pan 22 to move as required and (c) by flexing, it enables pressure within the sealed enclosure 19 to be kept equal with external pressure, despite barometric pressure changes, temperature changes etc.

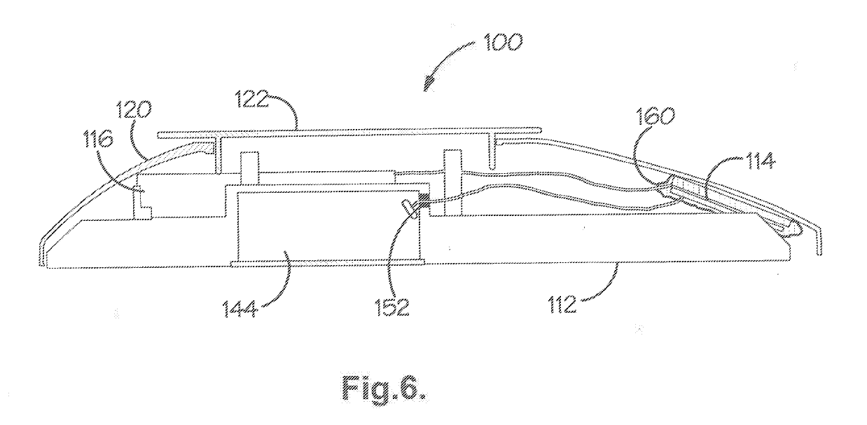

FIG. 6 illustrates second scales 100 embodying a different aspect of the invention. In this embodiment the approach taken to prevention of water damage during washing is to form individual enclosures around the parts that require protection, but to allow water to enter—and subsequently drain from—the interior of the scales' main housing. Many components of the second scales 100 are similar to the first scales 10, and will not be described again in detail. A base 112 defines a downwardly open and sealable battery compartment 144 from which wiring emerges through a seal 152 to connect to a display and control panel 114. A cover 120 of frusto-conical shape forms with the base 112 an enclosed space containing the scales' transducer 116 as well as the panel 114. Weighing pan 122 locates upon the cover 120 and its weight is carried through a support member 130 of the load cell 116 as in the first embodiment.

However the second embodiment differs from the first in that it does not have any counterpart to the membrane 18. Instead the display and control panel 114 is provided with its own enclosure 160, which in the illustrated embodiment is a sealed bag. The transducer 116 is formed suitably to survive washing, including immersion. For example where the transducer takes the form of a load cell, it may be sufficient for this purpose to encapsulate the resistive bridge circuit in potting compound. Other types of transducer capable of surviving contact with water may be used.

When immersed or washed in a dishwasher, the scales 100 of the second embodiment will partially or wholly fill with water but that causes no damage and the water subsequently drains, leaving the scales ready for use. Suitable drainage channels (not shown) may be incorporated in the housing formed by the base 112 and the cover 120, to hasten drainage.

In general, the product is designed such that water can drain away. This is important so that dirt does not remain trapped, and also so water does not remain; such water would cause there to be localised humid areas. In particular, it should be noted that methods of humidity regulation are defeated if pockets of water are allowed to remain in the product.

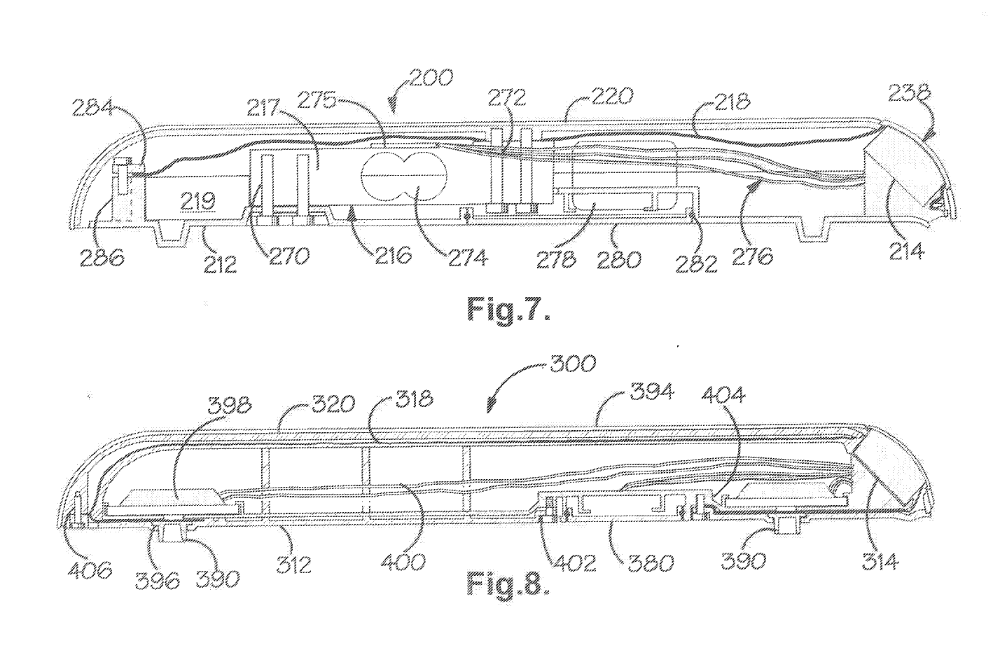

FIG. 7 illustrates third scales 200 embodying the present invention. Most of the functional components found in the first scales 10 have counterparts in the third scales 200, although they differ particularly in that (a) the third scales 200 do not have a sealed battery compartment separate from the enclosure containing the transducer and electronics; (b) in the third scales 200 the cover 220 that lies over membrane 218 and conceals the scales' interior working parts also serves as the weighing pan, being movable relative to base 212; and (c) the membrane 218 is secured and sealed at its periphery by mechanically engaging parts.

Looking at the construction of scales 200 in a little more detail, a load cell 216 comprises, as in previous embodiments, a cantilevered arm 217 one end portion of which is secured by mechanical fixings 270 to the scales' base 212 while the other end portion is secured by mechanical fixings 272 to the cover 220. A cut away 274 in the arm 217 facilitates flexure of the arm under load and this flexure is detected by a strain gauge 275 mounted upon the arm to provide a signal indicative of weight acting on the cover 220. The cover 220 serves as the weighing pan and is movable somewhat relative to the base 212. User interface 214 and its associated electronics are visible through a window 238 in the cover 220 and though the membrane 218. Wires 276 connect the user interface 214 both to the strain gauge 275 and to battery 278. The battery is in this embodiment disposed in the same sealed enclosure 219 that contains the load cell 216 and the user interface 214. A removable battery hatch 280 enables battery replacement and has a peripheral “O” ring seal 282 to prevent water ingress.

To the left of the drawing it can be seen that the periphery of the membrane 218 is trapped between opposing faces of a clamping part 284, formed in this embodiment as a flat ring, and of a complementarily shaped upstand 286 of the base 212. These parts are secured together by mechanical fixings, in the present embodiment, to form the required seal against water ingress. The membrane 218 may therefore be removable for access to interior components.

FIG. 8 illustrates fourth scales 300 embodying the present invention. These differ from the first scales 10 described above particularly in that the scales' entire housing 312, 320 serves as the weighing pan. Multiple movable feet 390 support the housing through respective transducers 392 so that signals output from the transducers provide, when summed, an indication of the weight of a load (not shown) placed on upper face 394 of the housing.

The scales 300 may have three or four feet 390, or some other number. In the embodiment depicted, each foot 390 is mushroom shaped, with a cylindrical body received in a circular opening in the base 312 and a flange 396 which engages with the periphery of the opening to render the foot captive. Above each foot is a respective transducer 398 mounted to base 312 so that upward force on the foot 390 is reacted to the base 312 through the transducer, which thus provides an output signal indicative of the force. Wires 400 connect each transducer to user interface 314 and associated electronics which, by summing the transducer's outputs and deducting weight of the scales' housing and its contents, are able to measure and display weight of the load on surface 394.

Membrane 318 has a bag-like shape in this embodiment, extending across the base 312 and having a relatively small mouth whose periphery is trapped and so sealed between opposed surfaces of an upstand 402 of the base 312 and a shallow a tray 404 which is bolted to the base 312. The upstand 402 surrounds battery hatch 380 so that the membrane 318 does not prevent battery replacement. The base 312 and the cover 320 need not be capable of relative movement in this embodiment and are bolted together as seen at 406.

Note that the weight being measured is, in this embodiment as in the first and third scales 10, 200, transmitted through the membrane 318.

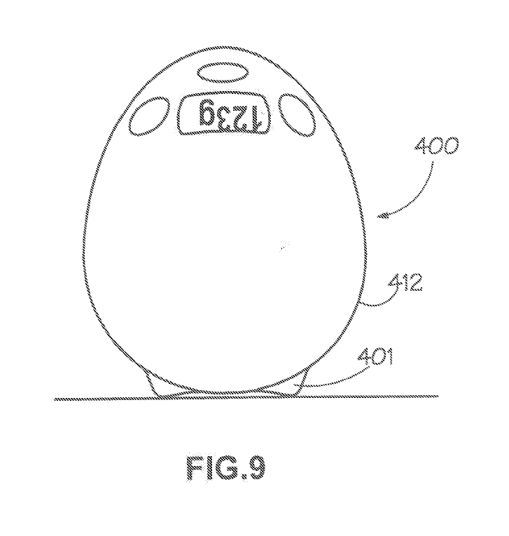

FIG. 9 illustrates fifth scales 400 embodying the present invention. These have a housing 412 which is adapted to stand upright. To this end it has feet 401 to provide stable support for the housing in its upright configuration. The feet may be integrally formed with the housing 412 or may be attached to it. The term “feet” in this context should be broadly understood to refer to any feature of the shape of the housing, or any part attached to it, which enables the housing 412 to stand upright and in a particular orientation. Various advantages are provided in this way. Controlling orientation within the rack or loading area of a dishwasher may enhance product lifetime by assisting drainage and shedding of water. Compact vertical storage is also facilitated.

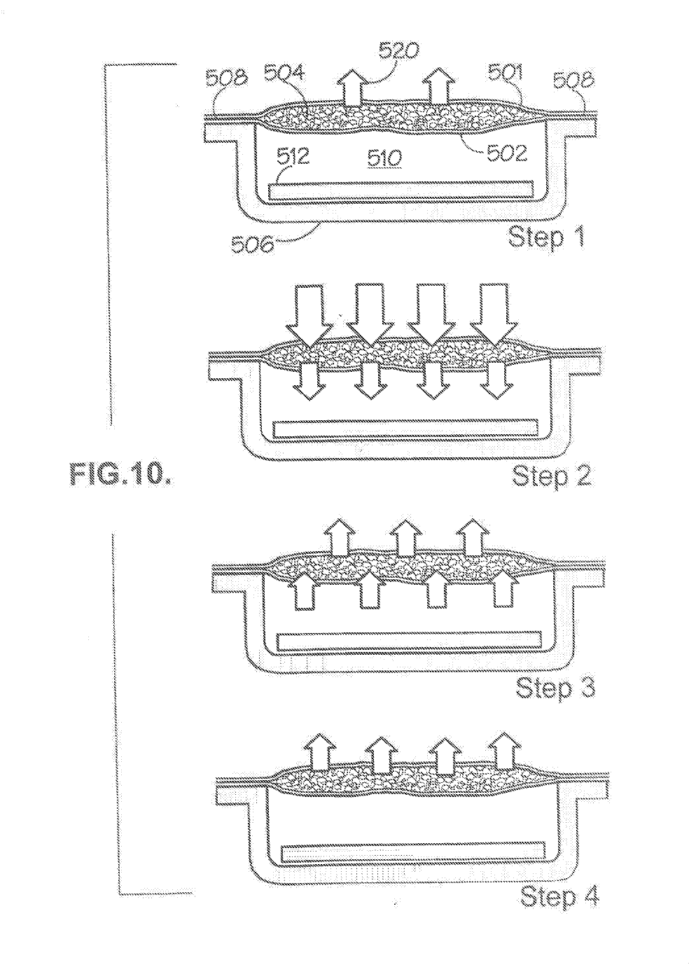

FIG. 10 shows schematically how the use of a double film enclosing a saturated salt solution may be used in the present invention. Said double film can advantageously be used as the water-tight membrane, or to provide the waterproof enclosure, in respect of previously described aspects and embodiments.

FIG. 10 shows a double film comprising a first film 501 and a second film 502 enclosing a saturated salt solution 504. The first film 501 and second film 502 are sealed to each other (thereby isolating the saturated salt solution in a salt pouch 504) and sealed to a base 506 (thereby forming a water-tight enclosure 510) at portions 508. Within watertight enclosure 510 are water-sensitive components 512.

The salt pouch does not necessarily need to cover the entire product. In some designs significant coverage is appropriate; in other designs a smaller extent of coverage is appropriate. A key requirement is to cover the water-sensitive components, including the electronic components. Nevertheless the arrangement should be such that the salt should not interfere with the operation of the product. For example the salt should be located so as not to interfere with the operation of the load cells by becoming entrapped between them and the external feet.

Whilst the enclosure 510 is waterproof, i.e. liquid water does not pass through the films, nevertheless water vapour can permeate through the films as illustrated by arrows 520. Steps 1 to 4 show how the water vapour transmission can vary at different stages and under different conditions.

In step 1 the humidity in the salt pouch 504 is the same as the humidity in the internal volume (enclosure 510), and there is limited moisture exchange with the external environment. Assuming that a suitable saturated solution is used, moisture will be vented out of the salt pouch to the external environment.

In step 2 the product has been exposed to heat. This occurs when for example the product is washed in a dishwasher. The heat increases the film permeability and increases the capacity of the internal volume to hold moisture. A pressure gradient forces the water vapour in. The presence of the salt pouch hinders the transfer of vapour into the inner volume 510. In effect the salt creates a humidity barrier, reducing the rate of moisture transmission.

In step 3 the internal volume 510 cools and its capacity to hold water vapour decreases. Transfer of moisture occurs via the salt pouch to the external ambient environment.

In step 4 the humidity of the internal volume has equilibrated with the salt pouch and moisture continues to be released to the external environment. The situation will eventually become as illustrated in step 1.

It can be seen that the salt pouch acts as a fixed humidity point which effectively regulates the rate at which humidity can enter the product. Since the equilibrium humidity of the saturated salt solution does not change appreciably with temperature, there is a reduced thermodynamic driver (difference in vapour pressure) for water vapour to ingress into the product compared to what would normally happen due to high temperature washing.

Therefore the salt pouch results in less water vapour entering the internal volume and therefore greatly reduces the risk of damaging condensation.

Some non-limiting examples of suitable film coverage, film thickness, diffusivity and internal volume are as follows.

### Example A

Internal volume: 111.2 cm³

Surface area (per film): 145.8 cm²

Water vapour diffusivity (at 25 C): 2.024×10⁻¹¹ m²/s

Film thickness: 25 μm

### Example B

Internal volume: 313.3 cm³

Surface area (per film): 259.2 cm²

Water vapour diffusivity (at 25 C): 2.428×10⁻¹¹ m²/s

Film thickness: 30 μm

Optionally, in general, the diffusivity of the film may be within the range (at 25 C): 1.5×10⁻¹¹ m²/s to 3×10⁻¹¹ m²/s, e.g. 2×10⁻¹¹ m²/s to 2.5×10⁻¹¹ m²/s.

In terms of the transmission rate in respect of the scales, a useful measure is the water vapour diffusivity multiplied by the film area divided by film thickness and divided by volume. In respect of Example A this is 1.0615×10⁻⁴ s⁻¹ and in respect of Example B this is 6.696×10⁻⁵ s⁻¹, at 25° C. In general, optionally, this value may range between about 1×10⁻⁶ and about 0.01 s⁻¹, e.g. between about 1×10⁻⁵ and about 1×10⁻³ s⁻¹, e.g. between about 5×10⁻⁵ and about 1.2×10⁻⁴ s⁻¹.

Optionally, in general, whilst a preferred method of humidity regulation comprises the use of a saturated salt solution between two films as described herein, an alternative approach would be to use a single film carrying a salt, e.g. infused with sodium chloride.

The aforegoing embodiments have been presented by way of example and not limitation. Modifications of shape, proportion, constructional techniques and materials may be made without departing from the scope of the invention as defined by the appended claims.

1. Scales comprising at least one transducer, a weighing pan arranged such that weight applied to the weighing pan is referred to the transducer, and electronics which receive an output from the transducer and drive a display to provide a user with a visible indication of the weight applied to the weighing pan, wherein the transducer and the electronics are contained in a sealed enclosure defined at least in part by a flexible water-tight membrane which is able to move and thereby (a) to accommodate changes of volume of the sealed enclosure without creating a pressure differential between the interior and the exterior of the sealed enclosure and (b) to accommodate movement of the weighing pan.

2. Scales as claimed in claim 1 in which the water-tight membrane is transparent and the display is within the sealed enclosure, being viewable through the water-tight membrane.

3. Scales as claimed in claim 1 in which user controls are within the sealed enclosure and are actuable by a user through the water-tight membrane.

4. Scales as claimed in claim 1 in which weight applied to the weighing pan is referred to the transducer through the water-tight membrane.

5. Scales as claimed in claim 1 in which the weighing pan is inside the sealed enclosure.

6. Scales as claimed in claim 1 in which the weighing pan is outside the sealed enclosure.

7. Scales as claimed in claim 1 having a housing which serves as the weighing pan and is provided with multiple depending feet through which the scales are able to stand upon a supporting surface, each foot being provided with a respective transducer arranged to measure force referred through the foot to the housing.

8. Scales as claimed in claim 1 further comprising a battery compartment which is openable to replace batteries and is provided with a seal to exclude water when the battery compartment is closed.

9. Scales as claimed in claim 1 in which the water-tight membrane comprises flexible plastics.

10. Scales as claimed in claim 1 in which the water-tight membrane forms a seal along its periphery with a base or housing of the scales, so that the sealed enclosure is defined by the base and the water-tight membrane together.

11. Scales as claimed in claim 1 further comprising a cover placed over the water-tight membrane.

12. Scales as claimed in claim 1 in which a cover comprises a cut-away or window through which the display is viewable.

13. Scales as claimed in claim 1 which are capable of being washed in a dishwasher without suffering damage.

14. Scales comprising a housing, a weighing pan, and a transducer contained in the housing and arranged to support weight applied to the weighing pan so that the transducer provides an output indicative of the applied weight, a display supported by the housing and viewable from its exterior, and electronics connected to the transducer and to the display, the electronics receiving the transducer output and driving the display in response to provide a user with a visual indication of the applied weight, wherein the housing is permeable to water and the electronics and the display are protected in a waterproof enclosure, enabling the scales to be washed with water without damage.

15. Scales as claimed in claim 14 in which the housing forms the weighing pan.

16. Scales as claimed in claim 15 in which the housing is provided with multiple depending feet through which the scales are able to stand upon a supporting surface, each foot being provided with a respective transducer arranged to measure force referred through the foot to the housing.

17. Scales as claimed in claim 14 further comprising a sealable battery compartment from which conductors lead to the electronics.

18. Scales as claimed in claim 14 provided with drainage channels to promote egress of water from the housing after washing.

19. Scales as claimed in claim 14 which are capable of being washed in a dishwasher without suffering damage.

20. Scales as claimed in claim 1, which are adapted to stand upon a horizontal surface in an upright configuration.

21. Scales as claimed in claim 1, wherein the water-tight membrane comprises one or more film or plastic material or laminate.

22. Scales as claimed in claim 21 wherein a film or plastic material comprises one or more of polypropylene (PP), polyethylene (PE), high density polyethylene (HDPE), a polyester, polyethylene terephthalate (PET), polystyrene (PS), high-impact polystyrene (HIPS), polycarbonate (PC), polyvinylidene flouride (PVDF), polyvinylidene chloride (PVDC) or a cyclic olefin copolymer (COC).

23. Scales as claimed in claim 22 wherein the film or plastic material comprises polypropylene.

24. Scales as claimed in claim 21 wherein the water-tight membrane comprises two or more films.

25. Scales as claimed in claim 21 wherein the water-tight membrane comprises a double film comprising a saturated salt solution between two films.

26. Scales as claimed in claim 25 wherein the salt comprises sodium chloride.

27. (canceled)

28. Scales as claimed in claim 14 wherein the waterproof enclosure is provided at least in part by one or more film or plastic material.

29. Scales as claimed in claim 28 wherein a film or plastic material comprises one or more of polypropylene (PP), polyethylene (PE), high density polyethylene (HDPE), a polyester, polyethylene terephthalate (PET), polystyrene (PS), high-impact polystyrene (HIPS), polycarbonate (PC), polyvinylidene flouride (PVDF), polyvinylidene chloride (PVDC) or a cyclic olefin copolymer (COC).

30. Scales as claimed in claim 28 wherein a film or plastic material comprises polypropylene.

31. Scales as claimed in claim 28 wherein a boundary of the waterproof enclosure is defined at least in part by two or more films.

32. Scales as claimed in claim 28 wherein a boundary of the waterproof enclosure is defined at least in part by a double film comprising a saturated salt solution between two films.

33. Scales as claimed in claim 28 wherein the salt comprises sodium chloride.
